(19) United States
(12) Patent Application Publication
(10) Pub. No.: US 2013/0251162 A1
(43) Pub. Date: Sep. 26, 2013

(54) AUDIO MONITORING DEVICE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: XIAO-LIAN HE, Shenzhen (CN); TEN-CHEN HO, New Taipei (TW)

(73) Assignees: HON HAI PRECISION INDUSTRY CO., LTD., 66, Chung Shan Road, Tu-Cheng Dist. (TW); HONG FU JIN PRECISION INDUSTRY (ShenZhen) CO., LTD, Shenzhen (CN)

(21) Appl. No.: 13/755,357

(22) Filed: Jan. 31, 2013

(30) Foreign Application Priority Data
Mar. 26, 2012 (CN) 201220115834.3

(51) Int. Cl. H04R 29/00

(52) U.S. Cl. CPC H04R 29/00
USPC 381/58

(57) ABSTRACT

An audio monitoring device for testing an audio device is provided. The audio device is placed in a shielding room which contains a signal emitter. The signal emitter emits electromagnetic waves which electronically interfere with the audio device. The audio monitoring device includes a sound collector, a sound transmitting tube, and a sound outputting element. The sound collector is positioned in the shielding room and collects sounds from the audio device produced whilst being subjected to the electromagnetic interference issued by the signal emitter. The sound transmitting tube has one end connected to the sound collector and the other end exposed from the shielding room, to connect to the sound outputting element. The sound transmitting tube transmits the sounds collected by the sound collector to the sound outputting element for analysis.

### BACKGROUND

1. Technical Field

The present disclosure generally relates to audio monitoring devices, especially to an audio monitoring device for testing anti-electromagnetic interference properties of audio devices.

2. Description of Related Art

Audio devices are subjected to tests of immunity against ambient electromagnetic interference to determine the devices' anti-electromagnetic interference properties. During the testing, a signal emitter (i.e., an antenna) is placed adjacent to the audio device to emit special electromagnetic signals for interfering with the audio device, and testers will test the audio signal of the audio device to determine the quality of the audio output of the audio device as well as the anti-electromagnetic interference property. However, current tests are prone to interference from extraneous environmental sounds, which will cause an imprecise testing result for the audio device.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an audio monitoring device for monitoring an audio device in accordance with an exemplary embodiment.

FIG. 2 is an exploded view of an electromagnetic shield of the audio monitoring device of FIG. 1.

FIG. 3 is a schematic view of a shielding room in which the audio monitoring device is positioned.

### DETAILED DESCRIPTION

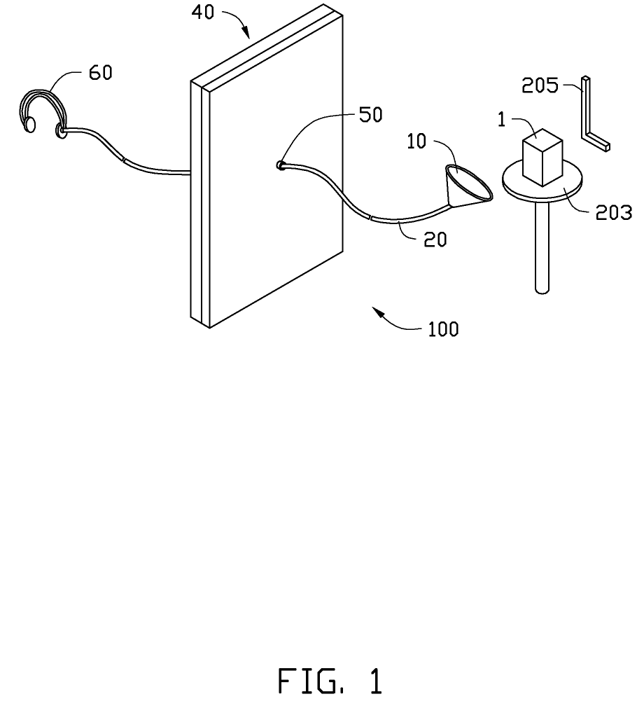

FIG. 1 shows an audio monitoring device 100 which can be used to test the audio qualities of an audio device 1 and its degree of immunity against electromagnetic interference. The audio device 1 may be, for example, a music player.

The audio monitoring device 100 includes a sound collector 10, a sound transmitting tube 20, an electromagnetic shield 40, a fastening element 50, and a sound outputting element 60.

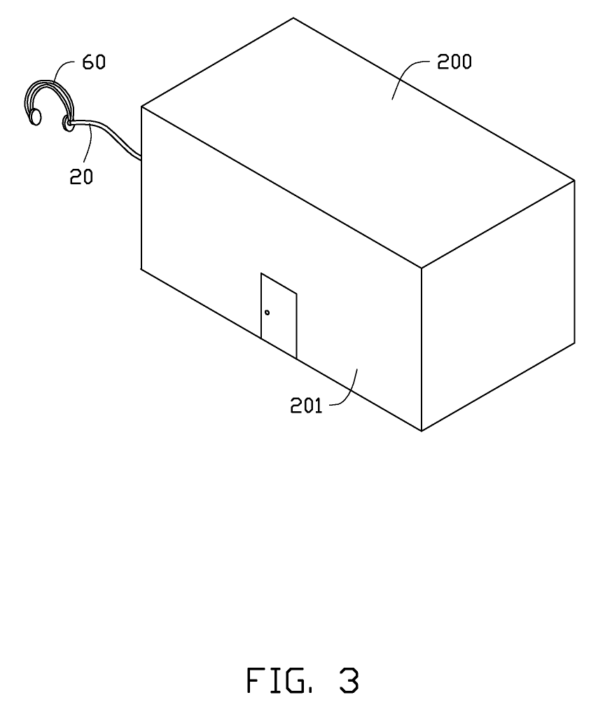

Also referring to FIG. 3, during testing, the audio device 1 is placed in a shielding room 200 to isolate against interference from extraneous environmental sounds. The shielding room 200 is an anechoic chamber which includes four sidewalls 201, a rotating table 203, and a signal emitter 205.

Wave-absorbing materials are attached to the sidewalls 201 on the inner surfaces thereof. The wave-absorbing materials absorb energies of the incident electromagnetic waves and reduce echoes and reflections of the electromagnetic waves within the anechoic chamber. The rotating table 203 is placed in the shielding room 200 for supporting and rotating the audio device 1. The signal emitter 205 is an antenna which can emit 80 MHz-1 GHz electromagnetic signals. The distance between the signal emitter 205 and the audio device 1 may be greater than 1 meter (m), and in the exemplary embodiment is 3 m. The rotating table 203 rotates the audio device 1, thus the audio device 1 can receive the interfering signals emitted by the signal emitter 205 in all orientations, thus enhancing the precision of testing the anti-electromagnetic interference property of the audio device 1.

The sound collector 10 has a larger, open, trumpet horn-shaped end. The open end of the sound collector 10 is aimed at the audio device 1 to collect the sounds emitted by the audio device 1. The sound collector 10 is non-metallic, such as polyvinyl chloride (PVC), to avoid any reflecting of the electromagnetic signals of the signal emitter 205 which might affect the test.

The sound transmitting tube 20 is a hose which has an end connecting to the smaller end of the sound collector 10 to transmit the sounds collected by the sound collector 10. The sound transmitting tube 20 is also non-metallic, such as PVC, for not reflecting the electromagnetic signals of the signal emitter 205.

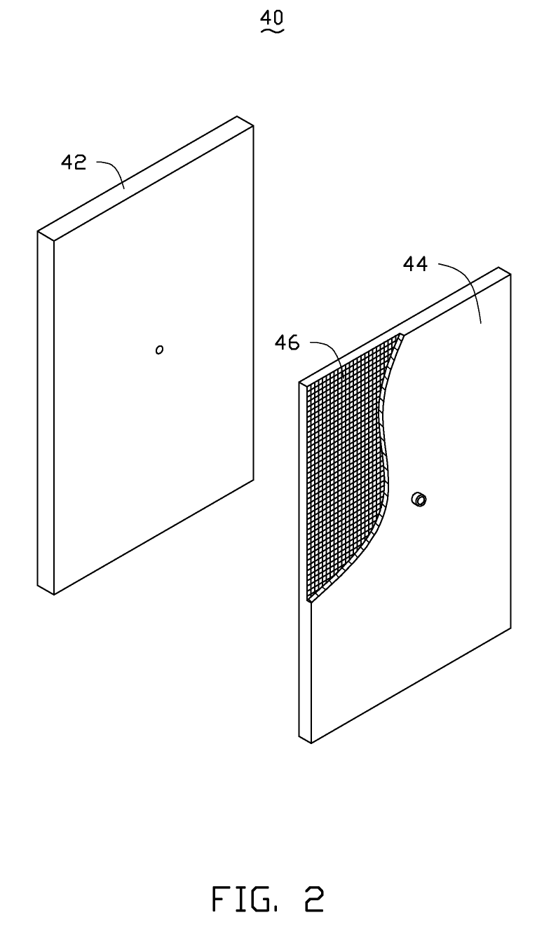

The electromagnetic shield 40 is fastened (such as by screws) on one sidewall 201 of the shielding room 200. The electromagnetic shield 40 has a size and a shape matching to the sidewall 201. Referring to FIG. 2 also, the electromagnetic shield 40 includes a fixing plate 42, a wave-absorbing plate 44 attached on the fixing plate 42, and a metal net 46 inserted in the wave-absorbing plate 44. The fixing plate 42 is fastened (i.e., by screws) on the sidewall 201 to prevent the ingress of external interfering signals into the shielding room 200. The fixing plate 42 may be made of iron, iron alloy, copper, copper alloy, aluminum, or aluminum alloy.

The wave-absorbing plate 44 is made of ferric oxide (Fe₂O₃). The metal net 46 is made of iron or copper. The wave-absorbing plate 44 and the metal net 46 absorb energies of the incident electromagnetic waves, thus reducing the effect of multipath anomalies in the reflecting and scattering of the electromagnetic waves during the test.

The fastening element 50 is a hollow pipe which has an inner diameter substantially equal to the outer diameter of the sound transmitting tube 20. The fastening element 50 passes through the electromagnetic shield 40 and the sidewall 201 and is secured in the electromagnetic shield 40 and the sidewall 201. The sound transmitting tube 20 passes through the fastening element 50 and is partially exposed from the shielding room 200. As such, the sounds emitted by the audio device 1 can be output from the shielding room 200 by the sound transmitting tube 20.

The sound outputting element 60 connects to the end of the sound transmitting tube 20 exposed from the shielding room 200 to receive the sounds from the sound transmitting tube 20, for a tester to listen and analyze.

During testing, referring to FIGS. 1 and 2, the sound collector 10 is placed adjacent to the audio device 1 and the open end of the sound collector 10 is aimed at the audio device 1. The signal emitter 205 emits electromagnetic waves in the frequency range described above to interfere with the audio device 1. While being subjected to the interference the audio device 1 emits sounds. The sounds are then collected by the sound collector 10 and transmitted to the sound outputting element 60 by the sound transmitting tube 20. Testers can test the audio device 1 by listening to the sounds output from the sound outputting element 60.

The exemplary audio monitoring device 100 defines the signal emitter 205 and the audio device 1 in the shielding room 200, which isolates and protects the audio device 1 from any externally-sourced sounds or electromagnetic interference, thus enhancing the precision of the test. Further, the sounds emitted by the audio device 1 are collected by the sound collector 10 and transmitted to the sound outputting element 60 by the sound transmitting tube 20, thus testing of the audio device 1 is convenient and entry into the shielding room 200 by the testers, which would affect the test precision, is avoided. Additionally, the wave-absorbing plate 44 and the metal net 46 of the electromagnetic shield 40 absorb all the incident electromagnetic waves, thus avoiding any electromagnetic effects or anomalies which may be induced by the reflecting and scattering of the electromagnetic waves within the anechoic chamber.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An audio monitoring device, the audio monitoring device being for testing an audio device which is placed in a shielding room having a signal emitter, the signal emitter emitting electromagnetic waves to interfere with the audio device, the audio monitoring device comprising:
a sound collector positioned in the shielding room, the sound collector collecting sounds emitted by the audio device while the audio device being subjected to the interfering electromagnetic waves of the signal emitter;
a sound outputting element; and
a sound transmitting tube having one end connecting to the sound collector and the other end exposing from the shielding room to connect the sound outputting element, the sound transmitting tube transmitting the sounds collected by the sound collector to the sound outputting element for testing.

2. The audio monitoring device as claimed in claim 1, wherein the sound collector has an open, trumpet horn-shaped end, the open end is aimed at the audio device to collect the sounds, the sound collector is non-metallic.

3. The audio monitoring device as claimed in claim 2, wherein the sound transmitting tube is a hose, the one end of the sound transmitting tube connects the end of the sound collector opposite to the open end, the sound transmitting tube is non-metallic.

4. The audio monitoring device as claimed in claim 1, wherein the audio monitoring device further comprises an electromagnetic shield fastened on a sidewall of the shielding room, the electromagnetic shield prevents the ingress of external interfering signals into the shielding room and absorbs energies of interfering electromagnetic waves.

5. The audio monitoring device as claimed in claim 4, wherein the electromagnetic shield comprises a fixing plate, the fixing plate is fastened on the sidewall, the fixing plate is made of iron, iron alloy, copper, copper alloy, aluminum, or aluminum alloy.

6. The audio monitoring device as claimed in claim 5, wherein the electromagnetic shield comprises a wave-absorbing plate attached on the fixing plate, and a metal net inserted in the wave-absorbing plate, the wave-absorbing plate is made of ferric oxide, the metal net is made of iron or copper.

7. The audio monitoring device as claimed in claim 4, wherein the audio monitoring device further comprises a fastening element, the fastening element is a hollow pipe which has an inner diameter equating to the outer diameter of the sound transmitting tube, the fastening element passes through the electromagnetic shield and the sidewall and is secured in the electromagnetic shield and the sidewall, the sound transmitting tube passes through the fastening element and partially exposes from the shielding room to connect the sound outputting element.

8. The audio monitoring device as claimed in claim 1, wherein the sound outputting element receives the sounds from the sound transmitting tube for testing.

9. The audio monitoring device as claimed in claim 1, wherein the signal emitter is an antenna which emits 80 MHz-1 GHz electromagnetic signals, the distance between the signal emitter and the audio device is greater than 1 meter.

10. The audio monitoring device as claimed in claim 9, wherein the distance between the signal emitter and the audio device is 3 meters.

11. The audio monitoring device as claimed in claim 4, wherein the shielding room is an anechoic chamber, wave-absorbing materials are attached to the sidewalls of the shielding room on the inner surface thereof to absorb electromagnetic waves.

12. The audio monitoring device as claimed in claim 1, wherein the shielding room further comprises a rotating table placed in the shielding room for supporting and rotating the audio device.

13. An audio monitoring device for testing an audio device, the audio monitoring device comprising:
a shielding room providing a signal emitter therein, the signal emitter emitting electromagnetic waves;
a sound collector positioned in the shielding room, the sound collector collecting sounds of the audio device emitted when being subjected to the interfering of the electromagnetic waves of the signal emitter;
a sound outputting element positioning outside of the shielding room; and
a sound transmitting tube having one end connecting to the sound collector and the other end exposing from the shielding room to connect the sound outputting element, the sound transmitting tube transmitting the sounds collected by the sound collector to the sound outputting element for analysis.
